(19) United States
(12) Patent Application Publication
(10) Pub. No.: US 2025/0168810 A1
(43) Pub. Date: May 22, 2025

(54) METHOD AND APPARATUS FOR ESTIMATING LOCATION USING MOBILE COMMUNICATION DATA BASED ON DEEP-LEARNING

(71) Applicant: ELECTRONICS AND TELECOMMUNICATIONS RESEARCH INSTITUTE, Daejeon (KR)

(72) Inventors: Ju Il JEON, Daejeon (KR); Young Su CHO, Daejeon (KR)

(21) Appl. No.: 18/931,502

(22) Filed: Oct. 30, 2024

(30) Foreign Application Priority Data
Nov. 20, 2023 (KR) 10-2023-0161554

(51) Int. Cl. H04W 64/00; H04B 17/318; H04W 24/02

(52) U.S. Cl. CPC H04W 64/00; H04B 17/318; H04W 24/02

(57) ABSTRACT

The present disclosure relates to a method and apparatus for estimating a location using mobile communication data based on deep learning. A method for estimating a location based on mobile communication data according to an embodiment of the present disclosure may comprise: collecting data from a plurality of mobile communication companies; learning a prediction model based on the collected data of the plurality of mobile communication companies; generating data of one or more other mobile communication companies by inputting data of a specific mobile communication company among the plurality of mobile communication companies into the learned prediction model; and estimating a location of a user based on the data of the specific mobile communication company and the generated data of one or more other mobile communication companies.

### CROSS-REFERENCE TO RELATED APPLICATION

This application claims the benefit of earlier filing date and right of priority to Korean Application No. 10-2023-0161554, filed on Nov. 20, 2023, the contents of which are all hereby incorporated by reference herein in their entirety.

### TECHNICAL FIELD

The present disclosure relates to a method and apparatus for estimating a location using mobile communication data based on deep learning.

### BACKGROUND

Location-based services may play an essential role in modern society and may be a key technology in various industries such as autonomous vehicles, smart cities, and various robotics technologies. Additionally, the accuracy of location information is very important in emergency rescue services, and providing quick and accurate location information over a wide area that can cover the entire country may be a critical factor in saving lives.

In this regard, GPS-based location estimation technology may mainly used, and may provide location information with a high level of location accuracy outdoors. However, the technology may have a large error in the estimated location or provide incorrect location information due to problems such as buildings blocking signals in indoor and densely populated areas in urban areas, signal strength being weakened, and signals being transmitted through multiple paths, which increases the error. In addition, in the case of the technology, since it takes a long time to find the initial location, it may be difficult to respond quickly in an emergency situation.

The problems of GPS-based location estimation technology as described above may be a major drawback in emergency rescue services, and various attempts are being considered to solve them.

In this regard, location estimation technology based on mobile communication data rather than GPS is being developed and discussed, and the technology may be implemented in various forms.

### SUMMARY

The technical object of the present disclosure is to provide a method and apparatus for estimating a location using mobile communication data based on deep learning.

The technical object of the present disclosure is to provide a method and apparatus for estimating a location using mobile communication data of multiple telecommunications companies generated and expanded using a deep learning model.

The technical object of the present disclosure is to provide a method and apparatus for integrating mobile communication data of various telecommunications companies and improving the accuracy of location estimation based thereon.

The technical objects to be achieved by the present disclosure are not limited to the above-described technical objects, and other technical objects which are not described herein will be clearly understood by those skilled in the pertinent art from the following description.

A method for estimating a location based on mobile communication data according to an aspect of the present disclosure may comprise: collecting data from a plurality of mobile communication companies; learning a prediction model based on the collected data of the plurality of mobile communication companies; wherein the prediction model is designed to receive data of a single mobile communication company and predict data of another mobile communication company; generating data of one or more other mobile communication companies by inputting data of a specific mobile communication company among the plurality of mobile communication companies into the learned prediction model; and estimating a location of a user based on the data of the specific mobile communication company and the generated data of one or more other mobile communication companies.

An apparatus of performing location estimation based on mobile communication data according to an additional aspect of the present disclosure may comprise at least one processor and at least one memory, and the processor may be configured to: collect data from a plurality of mobile communication companies; learn a prediction model based on the collected data of the plurality of mobile communication companies; wherein the prediction model is designed to receive data of a single mobile communication company and predict data of another mobile communication company; generate data of one or more other mobile communication companies by inputting data of a specific mobile communication company among the plurality of mobile communication companies into the learned prediction model; and estimate a location of a user based on the data of the specific mobile communication company and the generated data of one or more other mobile communication companies.

As one or more non-transitory computer readable medium storing one or more instructions according to an additional aspect of the present disclosure, the one or more instructions may be executed by one or more processors and control an apparatus for performing location estimation based on mobile communication data to: collect data from a plurality of mobile communication companies; learn a prediction model based on the collected data of the plurality of mobile communication companies; wherein the prediction model is designed to receive data of a single mobile communication company and predict data of another mobile communication company; generate data of one or more other mobile communication companies by inputting data of a specific mobile communication company among the plurality of mobile communication companies into the learned prediction model; and estimate a location of a user based on the data of the specific mobile communication company and the generated data of one or more other mobile communication companies.

In various aspects of the present disclosure, an operation of collecting the data may include an operation of performing a pre-processing process of converting the collected data into a data format for learning the prediction model. In this regard, the pre-processing process may include at least one of noise removal, outlier detection and removal, scaling for unit conversion, or feature extraction for the collected data. Additionally or alternatively, the pre-processed data may be stored and managed in the format of a database and the learning of the prediction model may be performed based on filtered data by loading data stored in the database.

Additionally, in various aspects of the present disclosure, the prediction model may be updated at a pre-configured cycle based on at least one of changes in learning data or changes in user requirements.

Additionally, in various aspects of the present disclosure, the data of the specific mobile communication company may be collected and transmitted by a user terminal and input into the learned prediction model through a pre-processing process including data format conversion.

Additionally, in various aspects of the present disclosure, the data of the multiple mobile communication companies may be collected simultaneously based on signals transmitted and received by each mobile communication company.

Additionally, in various aspects of the present disclosure, the collected data may include at least one of information on signal strength, information on frequency range, information on cell identifier, or information on channel.

Additionally, in various aspects of the present disclosure, the prediction model is based on a deep learning neural network structure designed to extract and analyze features of the data of the single communication company and infer data of other communication companies.

According to the present disclosure, a method and apparatus for estimating a location using mobile communication data of multiple telecommunications companies generated and expanded using a deep learning model may be provided.

According to the present disclosure, by expanding and utilizing mobile communication data of multiple telecommunications companies, the accuracy, stability, and reliability of location estimation may be improved.

According to the present disclosure, the limitations and problems of existing location estimation methods may be overcome by integrating and utilizing various algorithms and deep learning techniques necessary to improve the accuracy and stability of location estimation.

The effects obtainable from the present disclosure are not limited to the effects mentioned above, and other effects not mentioned will be clearly understood by a person skilled in the art to which the present disclosure belongs from the description below.

### BRIEF DESCRIPTION OF THE DRAWINGS

FIG. 1 illustrates a block diagram of a system for expanding mobile communication data based on deep learning according to an embodiment of the present disclosure.

FIG. 2 illustrates a detailed block diagram of a data collection and management unit (110) according to an embodiment of the present disclosure.

FIG. 3 illustrates a detailed block diagram of a deep learning-based mobile communication data prediction model generation unit (120) according to an embodiment of the present disclosure.

FIG. 4 illustrates a detailed block diagram of a deep learning-based position estimation unit (130) according to an embodiment of the present disclosure.

FIG. 5 illustrates a data collection path in a location estimation experiment according to an embodiment of the present disclosure.

FIG. 6 illustrates data collection points in a location estimation experiment according to an embodiment of the present disclosure.

FIG. 7 illustrates the results of a location estimation method according to an embodiment of the present disclosure and the results of a conventional position estimation method.

FIG. 8 illustrates an operation flowchart of a location estimation method based on mobile communication data according to an embodiment of the present disclosure.

FIG. 9 is a block diagram illustrating a device according to an embodiment of the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

In relation to location estimation technology, a location estimation technology based on mobile communication data may be considered to solve problems of GPS-based location estimation technology.

Additionally, technologies utilizing short-range wireless infrastructure data such as WiFi and Bluetooth Low Energy (BLE) may have excellent performance in certain environments. However, due to their own limitations, there are frequent cases where they do not provide the required level of accuracy in certain environments.

For example, in the case of a technology using WiFi-based data, it is mainly used indoors, and the location may be estimated based on the signal strength (e.g., received signal strength indicator (RSSI)) between an access point (AP) and a terminal (station, STA). Here, the signal strength may correspond to an indicator indicating how far the terminal is located from the WiFi AP.

However, in the case of WiFi, since signals may be easily blocked by walls and/or obstacles, the accuracy of location estimation may vary significantly depending on environmental factors. Additionally, there is a limitation that location estimation is not possible in places where WiFi APs are not installed.

For example, in the case of technology using BLE-based data, high-accuracy location estimation may be possible in a relatively narrow range, and may be used for indoor navigation, asset tracking, etc. BLE beacons are small and have the advantage of being energy-efficient, but have the disadvantage of requiring additional infrastructure for beacons. Therefore, location estimation technology using BLE-based data is difficult to use outside of public places and large buildings.

As a method to complement the problems of the technologies of the examples, a location estimation technology based on mobile communication data as described above may be considered. That is, a location estimation technology based on mobile communication data has the advantage of resolving the problems described above and being able to be used universally in a wide area.

Mobile communication data-based location estimation technology may be implemented in various forms.

For example, a method based on a cell identifier (Cell-ID) may be considered. This method is a method of finding the approximate location of a terminal by using the location information of a mobile communication base station to which the terminal requesting the current location is connected.

The cell identifier-based method may estimate the location relatively simply, but the accuracy may vary greatly depending on the service range of the base station. Because of this, the error range is likely to be large in complex urban areas and areas with densely packed tall buildings.

As another example, a time of arrival (ToA)-based method may be considered. This method measures the arrival times of signals transmitted from multiple mobile communication base stations to a terminal, and calculates the location of the terminal based on the difference in the arrival times.

The time-of-arrival-based method requires complex calculations, and it may be important to accurately measure the time at which a signal arrives. However, the method requires that time synchronization between base stations be performed accurately, and problems such as signal transmission delays may occur.

As another example, a time difference of arrival (TdoA)-based method may be considered. This method is a method of finding the location of a terminal by utilizing the difference in arrival times of signals received from a terminal by two or more base stations.

The method based on the time difference of arrival has the advantage of being able to obtain more accurate location information by analyzing data from various base stations together, but errors may occur due to various variables in complex environments.

As another example, an angle of arrival (AoA)-based method may be considered. This method is a method of finding the location of a terminal by analyzing the angle at which a signal transmitted from a terminal is received by two or more base stations.

The angle-of-arrival-based method requires that base stations accurately measure the direction of signals received from terminals, and complex factors such as the installation location of the base station and the characteristics of the receiving antenna shall be considered.

However, in relation to methods such as the examples described above, there may be several limitations in the case of existing methods that only use mobile communication data from a single telecommunications company.

To solve this problem, the present disclosure proposes a method for improving location estimation accuracy by utilizing mobile communication data from multiple communication companies.

Specifically, the present disclosure proposes a location estimation method utilizing extended mobile communication data using a deep learning technique. In the case of the method, the accuracy of location estimation may be improved by integrating and using mobile communication data from multiple telecommunication companies.

The proposed method in the present disclosure may be configured to include one or more of the following steps.
Step 1. Mobile communication data is collected simultaneously from multiple telecommunication companies, and the data set is used as training data for the deep learning model.
Step 2. Train a deep learning model using the collected data. Here, the deep learning model performs the role/function of receiving only data from a single telecommunications company as input and predicting mobile communication data from other telecommunications company(s).
Step 3. Input data from a single carrier into the prediction model, and generate mobile data from other carriers based on this.
Step 4. Perform location estimation using mobile communication data from multiple carriers generated and expanded using a deep learning model.

The method proposed in the present disclosure may provide improved accuracy and stability of location estimation compared to existing methods that use only data from a single telecommunications company.

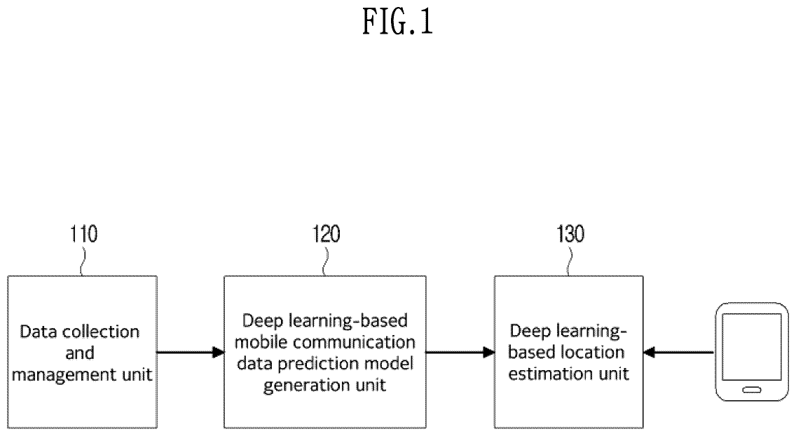

FIG. 1 illustrates a block diagram of a system for expanding mobile communication data based on deep learning according to an embodiment of the present disclosure.

Referring to FIG. 1, the system may include three core components: a data collection and management unit (110), a deep learning-based mobile communication data prediction model generation unit (120), and a deep learning-based location estimation unit (130).

The data collection and management unit (110) may be configured to collect data from various telecommunication companies, preprocess it to remove noise and outliers, and then safely store and manage it.

The deep learning-based mobile communication data prediction model generation unit (120) may train a deep learning model based on collected data, and may be configured to generate and manage a model that may predict mobile communication data of other communication company(s) using only data of a single communication company.

The deep learning-based location estimation unit (130) may be configured to predict mobile communication data of other telecommunications companies (s) based on mobile communication data of a single telecommunications company collected from the user's smartphone by utilizing the learned model as described above. Based on this, the deep learning-based location estimation unit (130) may estimate the location of the user terminal.

Hereinafter, the operation and configuration of each of the data collection and management unit (110), the deep learning-based mobile communication data prediction model generation unit (120), and the deep learning-based location estimation unit (130) in FIG. 1 will be described through detailed example(s).

First, the data collection and management department (110) will be described in detail.

The data collection and management unit (110) may be related to the basic process/function for constructing an efficient and accurate location estimation system.

The data collection and management unit (110) may be configured to simultaneously collect and preprocess mobile communication data from multiple telecommunication companies, and safely store and manage the results.

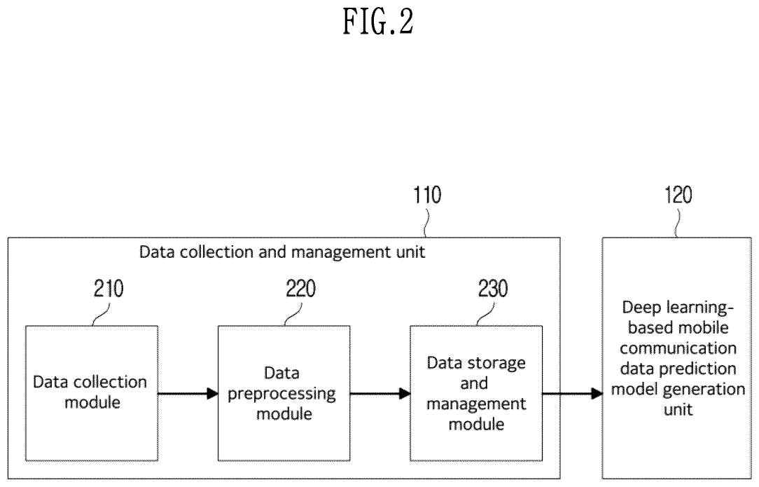

FIG. 2 illustrates a detailed block diagram of a data collection and management unit (110) according to an embodiment of the present disclosure.

Referring to FIG. 2, the data collection and management unit (110) may include a data collection module (210), a data preprocessing module (220), and a data storage and management module (230), and each module may be connected to each other and operate.

In this regard, each module Maycan perform complex data processing and management operations to perform the role/function of building a high-quality data set that may be utilized in the deep learning model training stage.

The operation of the data collection and management unit (110) as described above may secure high-quality data required for learning a deep learning model, and may be performed by utilizing systematic methods and technologies for efficiently managing the secured data.

Hereinafter, the functions and roles of each of the data collection module (210), the data preprocessing module (220), and the data storage and management module (230) will be described in detail.

The data collection module (210) may be configured to perform the role/function of simultaneously collecting mobile communication data from multiple communication companies.

For example, the data collection module (210) may perform a function of collecting various data in real time, thereby securing data occurring in various time zones and environments. This function may be important in obtaining a variety of data that may occur in various situations and conditions, and based on this, a more accurate prediction model may be generated.

Additionally, the data collection module (210) may collect a sufficient amount of data required for learning a deep learning model, i.e., a prediction model. In this regard, the data collection module (210) may quickly collect a large amount of data.

In this regard, the data collected needs to include all information required for various location estimation techniques, such as signal strength, frequency range, etc.

The data preprocessing module (220) may be configured to perform the role/function of processing and analyzing data collected from the data collection module (210) and converting it into a suitable form.

For example, the data preprocessing module (220) may filter out unnecessary information such as signal interference and/or noise through a noise removal process. Here, noise may be caused by various factors such as external environmental changes and device errors.

Additionally, the data preprocessing module (220) may detect and process inconsistent or exceptional values among the collected data through an outlier detection and removal process. Here, outliers may be caused by errors and/or incorrect inputs that may occur during the data collection process, and if outlier values remain, they may have a negative impact on the learning process of the deep learning model.

Additionally, the data preprocessing module (220) may convert collected data according to certain criteria through a data format conversion process and generate it into a format suitable for analysis and modeling. For example, data scaling, feature extraction, etc. may be performed during the process.

As described above, preprocessed data may correspond to data suitable for model learning.

The data storage and management module (230) may be configured to perform the role/function of safely and efficiently storing collected and pre-processed data.

For example, the data storage and management module (230) may manage all data according to certain criteria and perform the function of maintaining and protecting the quality of data.

First, the data storage and management module (230) may protect collected and preprocessed data through functions such as safely storing data, preventing data loss, and blocking access from the outside.

Next, the data storage and management module (230) may efficiently manage data. For example, in order to efficiently manage data that is continuously accumulated, the data storage and management module (230) may organize data and build and maintain a database (DB) to easily find necessary data.

As described above, the managed data is utilized as important information in the subsequent deep learning model learning step, and accurate model learning may be performed based on accurate data.

Next, the deep learning-based mobile communication data prediction model generation unit (120) is described in detail.

The deep learning-based mobile communication data prediction model generation unit (120) may be configured to perform a process/function of recognizing and learning complex data patterns and generating a highly accurate prediction model. Through this, a reliable and accurate prediction model may be generated.

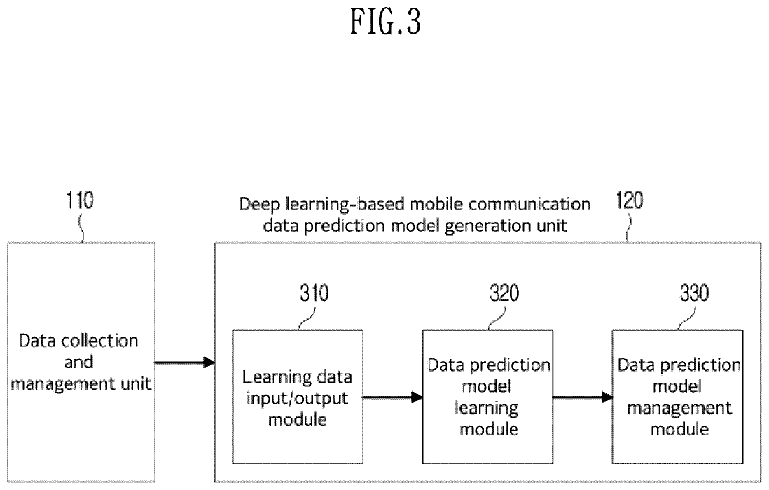

FIG. 3 illustrates a detailed block diagram of a deep learning-based mobile communication data prediction model generation unit (120) according to an embodiment of the present disclosure.

Referring to FIG. 3, the deep learning-based mobile communication data prediction model generation unit (120) may include a learning data input/output module (310), a data prediction model learning module (320), and a data prediction model management module (330), and each module may be connected to each other and operate.

The learning data input/output module (310) may be configured to perform a function of loading data managed by the data storage and management module (230) and then transferring it to the data prediction model learning module (320).

Additionally, the learning data input/output module (310) may perform a function of converting and generating optimal data required for model learning into an appropriate format. In this regard, the learning data input/output module (310) may perform a function of maintaining data consistency and selecting and extracting a specific data set required for learning.

Additionally, the learning data input/output module (310) may be configured to analyze the characteristics of data, filter out unnecessary data, and transmit only important data to the model learning process.

The process by the learning data input/output module (310) is an important process of processing and preparing data into a form suitable for model learning, and may have a significant impact on the efficiency and accuracy of overall model learning.

The data prediction model learning module (320) may perform a function of learning a deep learning model using the received data. In this regard, complex patterns may be recognized and learned using various layers and nodes.

Specifically, the data prediction model learning module (320) may extract features of mobile communication data of a single telecommunications company and generate a model capable of predicting mobile communication data of other telecommunications company(s), i.e., a data prediction model.

In such a learning process, the performance of the model (i.e., the data prediction model) may be optimized through processes such as network optimization and feature engineering. The learning process may correspond to a complex process of designing and training a deep neural network structure, and may include a process of finding an optimal model through tuning and experimenting with various hyper parameters.

The data prediction model management module (330) may perform the function of managing and storing a model generated by the data prediction model learning module (320). In this regard, model version management and update management may be performed for efficient management of the learned model.

Specifically, the data prediction model management module (330) may be configured to continuously monitor the performance of the model and, if necessary, update the model to maintain optimal performance.

Additionally, the data prediction model management module (330) is related to the life cycle management of the model and may perform the function of continuously improving and optimizing the model according to changes in learning data and/or changes in user requirements. In other words, the process may be essential for maintaining the stability and reliability of the system through performance evaluation and maintenance of the model.

As described above, the managed optimal learning model may be provided to the deep learning-based location estimation unit (130).

Next, the deep learning-based position estimation unit (130) will be described in detail.

The deep learning-based location estimation unit (130) may be related to a process/function for more accurately estimating the location of a user, i.e., a terminal (e.g., a user terminal).

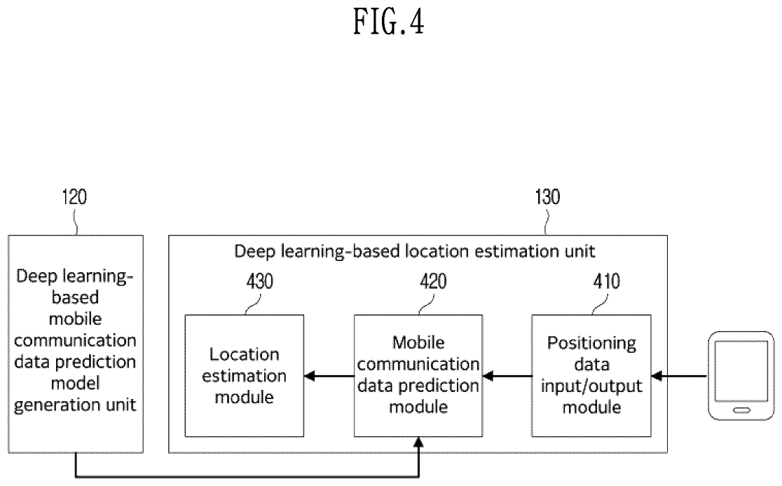

FIG. 4 illustrates a detailed block diagram of a deep learning-based position estimation unit (130) according to an embodiment of the present disclosure.

Referring to FIG. 4, the deep learning-based location estimation unit (130) may include a positioning data input/output module (410), a mobile communication data prediction module (420), and a location estimation module (430), and each module may be connected to each other and operate.

For example, each module may be interconnected to perform a process of predicting and generating mobile communication data of other carrier(s) based on data collected from a single carrier, and a process of estimating a location by utilizing the generated data.

The positioning data input/output module (410) may be configured to retrieve mobile communication data of a single telecommunications company collected by a user's terminal (e.g., a smartphone, etc.), extract data such as collected signal information, signal strength, and frequency, convert the data into a form suitable for a learned model, and transmit it to the mobile communication data prediction module (320).

In this regard, along with data format conversion, data noise removal and normalization tasks may also be performed by the positioning data input/output module (410) as needed.

The process by the positioning data input/output module (410) may be to accurately predict/generate mobile communication data of another telecommunications company based on mobile communication data of a single telecommunications company collected in real time at the user's current location.

The mobile communication data prediction module (420) may be configured to predict mobile communication data of other telecommunications company(s) based on data received from the positioning data input/output module (410) and a prediction model received from the deep learning-based mobile communication data prediction model generation unit (120).

In the prediction process described above, the mobile communication data prediction module (420) may be configured so that a deep learning-based prediction model analyzes the data characteristics of a single telecommunications company and infers mobile communication data of other telecommunications company(s) based on the data characteristics.

Through the process by the mobile communication data prediction module (420), mobile communication data required for positioning is expanded, and the user's location may be estimated more accurately based on the expanded mobile communication data. The process requires high computational power and may be performed by utilizing complex algorithms and deep learning-based models.

The location estimation module (430) may be configured to estimate the user's location using mobile communication data of other telecommunications companies (s) generated and extended by the mobile communication data prediction module (420).

In this regard, the location estimation module (430) may comprehensively analyze mobile communication data of other communication companies to estimate the user's exact location. Here, location estimation is performed using various algorithms, etc., and the location estimation module (430) may provide accurate location information by utilizing the prediction data generated in the process as efficiently as possible.

Additionally, the location estimation module (430) may be configured to provide/display the location estimation results to the user in various forms (e.g., coordinates, marks on a map, etc.).

Hereinafter, a detailed example of location estimation according to the proposed method in the above-described disclosure is described.

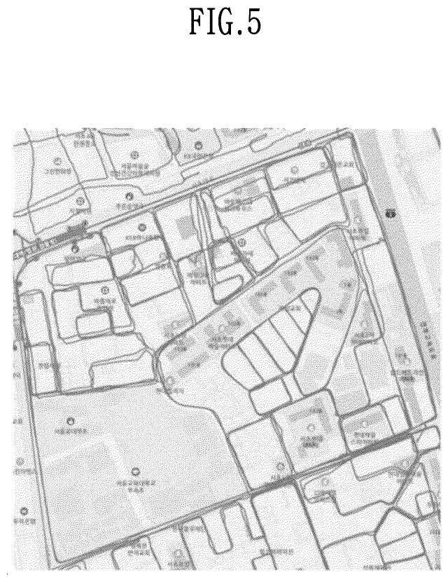

FIG. 5 illustrates a data collection path in a location estimation experiment according to an embodiment of the present disclosure.

Referring to FIG. 5, as an experiment for verifying the proposed method of the present disclosure, the experiment was conducted based on actual commercial mobile communication data collected in a specific area (e.g., Seocho 1-dong, Seocho-gu, Seoul). In this regard, LTE cell information data of three mobile communication companies (e.g., KR, SKT, LGU+) were used in the experiment.

Data from three mobile carriers were collected simultaneously by repeating all possible routes of the vehicle twice using a mobile collection device attached to the vehicle. For example, in the experiment, approximately 14,000 pieces of mobile data were collected for each carrier.

As described above, the collected data is used to build a database for generating learning data. The database is converted into final learning data through a preprocessing process required for generating learning data.

For example, among the collected LTE cell information, physical cell inidicator (PCI) and channel data may be preprocessed to generate a string format such as “PCI_CH”, and data for deep learning model training may be configured including both serving cells and neighbor cells.

In this regard, data for deep learning model training purposes camay be generated by grouping three simultaneously collected mobile communication data. Each data for deep learning model training purposes may include information that may uniquely identify a specific LTE cell.

Table 1 shows examples of data for training deep learning models generated based on three mobile communication data.

TABLE 1

| KT | SKT | LGU+ |
|---|---|---|
| 176_475, | 268_275, | 234_3050, |
| 176_1550, | 368_1350, | 234_100, |
| 379_1550 | 368_2500 | 234_2600 |
| 410_1550, | 97_275, | 488_3050, |
| 176_1550 | 123_2500, | 488_100, |
| | 31_1350, | 488_2600 |
| | 97_1350 | |
| 28_1694, | 187_275, | 167_100, |
| 410_3743 | 357_275, | 488_100 |
| | 357_3200, | |
| | 428_275 | |
| 116_1550, | 333_1350, | 234_3050, |
| 116_475, | 333_2500, | 412_3050, |
| 293_1550, | 333_275, | 69_3050 |
| 300_1550 | 368_1350 | |
| \| | \| | \| |
| \| | \| | \| |
| 298_475, | 126_275, | 356_100, |
| 429_475 | 136_275, | 432_100 |
| | 347_275, | |
| | 63_275 | |

In this experiment, a mobile communication data prediction model was trained using training data for a sequence-to-sequence (seq2seq) model.

Here, the seq2seq model corresponds to a deep-learning model used in various tasks such as natural language processing, machine translation, and speech recognition, and may perform a function of converting one sequence into another sequence. Additionally, the sea2seq model may process even when input sequences and output sequences may have different lengths, and thus may be suitable for processing LTE cell information having different lengths for each telecommunications company.

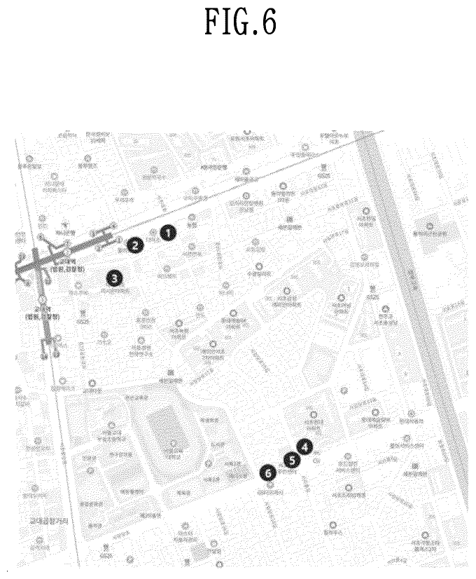

FIG. 6 illustrates data collection points in a location estimation experiment according to an embodiment of the present disclosure.

Referring to FIG. 6, in the experiment, a position estimation test was performed at six points. At this time, a total of 30 test data were collected at each point, and a total of 180 position estimation tests were performed.

By inputting unique LTE cell information (e.g., PCI, channel, etc.) of a specific mobile carrier (e.g., KT) collected at each test point into the mobile communication data prediction model learned using the aforementioned seq2seq model, LTE cell information of other mobile carriers (e.g., SKT, LGU+) may be predicted.

Table 2 illustrates data from other carriers predicted based on data from a specific carrier among the three carriers.

TABLE 2

| Test | | | |
|---|---|---|---|
| Point | Test KT | Predicted SKT | Predicted LGU+ |
| 1 | 410_1550, | 307_2500, | 167_100, |
| | 28_1694, | 307_275, | 488_100, |
| | 176_1694, | 357_3200, | 488_2600 |
| | 176_475 | 72_2850, | |
| | | 72_3200, | |
| | | 97_275 | |
| 2 | 410_1550, | 307_2500, | 488_100, |
| | 176_1694, | 307_275, | 488_2600, |
| | 176_475 | 357_275, | 488_3050 |
| | | 357_3200 | |
| 3 | 410_1550, | 307_2500, | 167_100, |
| | 176_1694, | 307_275, | 488_100, |
| | 28_1694, | 341_275, | 488_2600, |
| | 175_1694, | 97_1350, | 488_3050 |
| | 176_475 | 97_2500, | |
| | | 97_275 | |
| 4 | 298_1550_2529805, | 126_275, | 432_100, |
| | 354_1550, | 136_275, | 432_2600, |
| | 167_475, | 347_1350, | 432_3050 |
| | 298_3743 | 36_1350, | |
| | | 36_2500, | |
| | | 36_275 | |
| 5 | 429_1550, | 347_1350, | 116_3050, |
| | 367_1550, | 36_1350, | 406_3050, |
| | 429_475, | 36_2500, | 87_3050 |
| | 298_475, | 66_2500, | |
| | 429_3743 | 73_1350, | |
| | | 73_2500 | |
| 6 | 291_1550_3528709, | 0_2500, | 269_100, |
| | 404_1550, | 0_275, | 269_2600, |
| | 429_1550, | 126_1350, | 269_3050, |
| | 404_3743, | 36_1350, | 406_100 |
| | 429_3743 | 36_2500, | |
| | | 36_275 | |

As described above, location estimation may be performed using predicted and extended test data. With respect to location estimation, by comparing three pieces of mobile communication data stored in a positioning database with predicted and generated mobile communication data for positioning, the weighted sum of locations with the maximum similarity matching may be estimated as the final location.

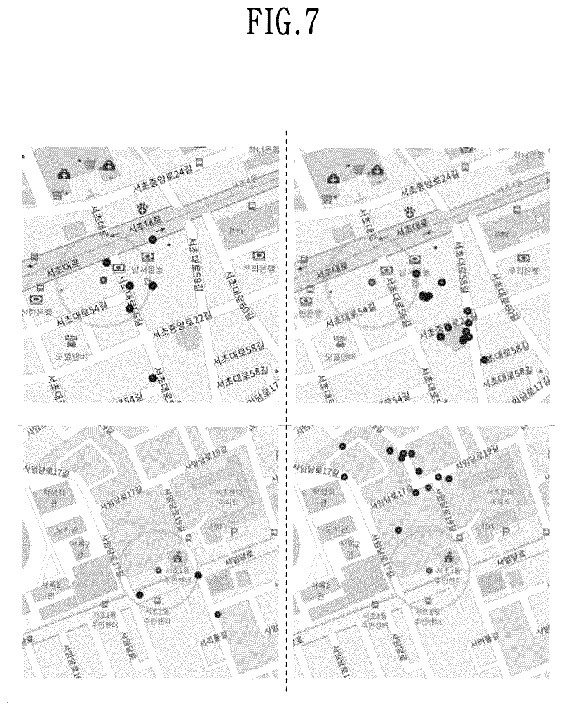

The results of estimating a location by considering predicted and extended mobile communication data (e.g., LTE cell information, channel) and the results of estimating a location using only mobile communication data of a single telecommunications company (e.g., KT) may be compared as shown in FIG. 7.

FIG. 7 illustrates the results of a location estimation method according to an embodiment of the present disclosure and the results of a conventional position estimation method.

Referring to FIG. 7, the left side of FIG. 7 illustrates a location estimation result based on predicted and extended mobile communication data according to an embodiment of the present disclosure, and the right side of FIG. 7 illustrates a location estimation result based on a conventional single mobile communication data.

The method using a single mobile communication data shows an average positioning error of 76.24 m. On the other hand, the method using mobile communication data predicted and expanded through deep learning shows an average positioning error of 63.88 m, which is lower than the fingerprint method.

According to the results of the above-described experiment, it may be proven that the deep learning-based extended mobile communication data-based positioning method proposed in the present disclosure enables more accurate location estimation compared to the method using a single mobile communication data.

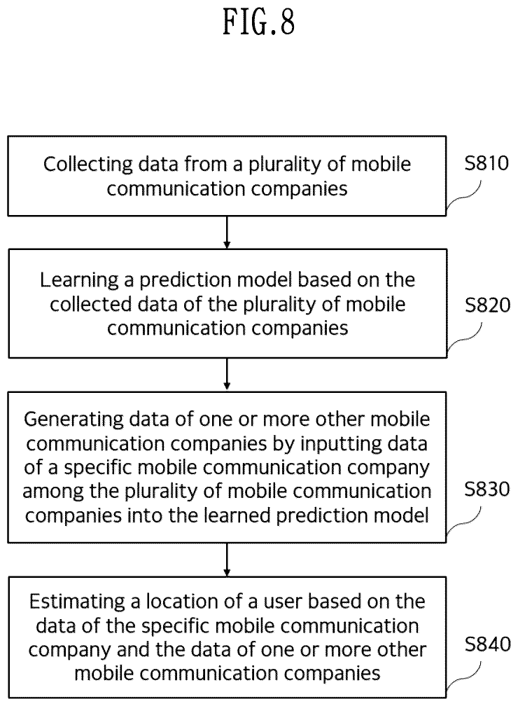

FIG. 8 illustrates an operation flowchart of a location estimation method based on mobile communication data according to an embodiment of the present disclosure.

The procedure described in FIG. 8 may be based on the methods and examples described above in the present disclosure.

First, data (i.e., mobile communication data) may be collected from multiple mobile communication companies (S810).

For example, data may be collected from multiple mobile carriers and a preprocessing step may be performed to convert the collected data into a data format for learning a prediction model.

Here, the preprocessing process may include at least one of noise removal, outlier detection and removal, scaling for unit conversion, or feature extraction for the collected data.

Additionally or alternatively, the preprocessed data is stored and managed in the form of a database, and learning of the prediction model may be performed based on filtered data by loading data stored in the database.

Additionally or alternatively, data of the plurality of mobile carriers may be collected simultaneously based on signals transmitted and received by each mobile carrier. In this regard, the collected data may include at least one of information on signal strength, information on frequency range, information on cell identifier, or information on channel.

As described above, a prediction model may be learned based on data from a number of mobile carriers collected (S820).

Here, the prediction model may be designed to receive data from a single telecommunications company and predict data from another telecommunications company. For example, the prediction model may be based on a deep learning neural network structure designed to extract and analyze features of data from the single telecommunications company and infer data from another telecommunications company.

Additionally or alternatively, the predictive model may be updated at preset intervals based on at least one of changes in the training data or changes in the user's requirements.

When a prediction model is learned, data of a specific mobile carrier among the plurality of mobile carriers may be input into the learned prediction model to generate data of one or more other mobile carriers (S830).

In this regard, data of the specific mobile carrier may be collected and transmitted by the user terminal, and may be input into the learned prediction model through a pre-processing process including data format conversion.

Finally, the user's location may be estimated based on the data of a specific mobile carrier and the data of one or more other mobile carriers generated above (S840).

As in the procedure described above in the present disclosure, by considering mobile data of another carrier predicted and extended based on mobile data of a single carrier, the reliability and accuracy of location estimation may be improved.

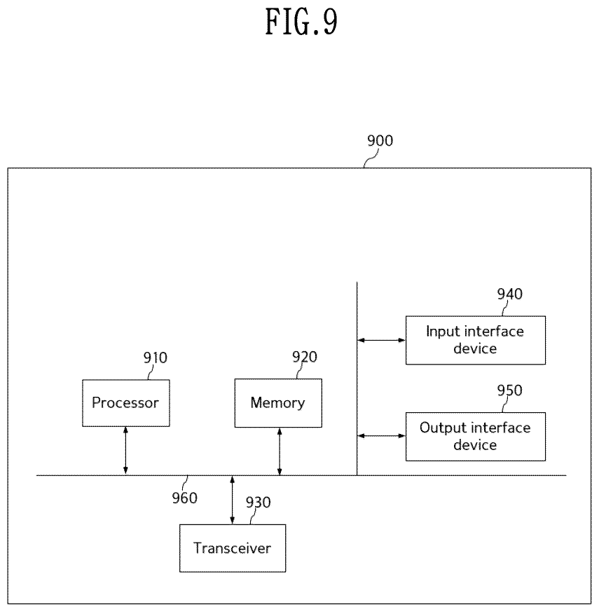

FIG. 9 is a block diagram illustrating an apparatus according to an embodiment of the present disclosure.

Referring to FIG. 9, the device (900) may represent a device in which the predicted and extended mobile communication data-based location estimation method described in the present disclosure is implemented.

The device 900 may include at least one of a processor 910, a memory 920, a transceiver 930, an input interface device 940, and an output interface device 950. Each of the components may be connected by a common bus 960 to communicate with each other. In addition, each of the components may be connected through a separate interface or a separate bus centering on the processor 910 instead of the common bus 960.

The processor 910 may be implemented in various types such as an application processor (AP), a central processing unit (CPU), a graphic processing unit (GPU), etc., and may be any semiconductor device that executes a command stored in the memory 920. The processor 910 may execute a program command stored in the memory 920. The processor (910) may be configured to implement the location estimation method and system based on predicted and extended mobile communication data as described above in FIGS. 1 to 8.

And/or, the processor 910 may store a program command for implementing at least one function for the corresponding modules in the memory 920 and may control the operation described based on FIGS. 1 to 8 to be performed.

The memory 920 may include various types of volatile or non-volatile storage media. For example, the memory 920 may include read-only memory (ROM) and random access memory (RAM). In an embodiment of the present disclosure, the memory 920 may be located inside or outside the processor 910, and the memory 920 may be connected to the processor 910 through various known means.

The transceiver 930 may perform a function of transmitting and receiving data processed/to be processed by the processor 910 with an external device and/or an external system.

The input interface device 940 is configured to provide data to the processor 910.

The output interface device 950 is configured to output data from the processor 910.

According to the present disclosure, a method and device for estimating a location using mobile communication data of multiple communication companies generated and expanded using a deep learning model may be provided.

According to the present disclosure, by expanding and utilizing mobile communication data of multiple communication companies, the accuracy, stability, and reliability of location estimation may be improved.

According to the present disclosure, the limitations and problems of existing location estimation methods may be overcome by integrating and utilizing various algorithms and deep learning techniques necessary to improve the accuracy and stability of location estimation.

According to the present disclosure, unlike the method of utilizing only data from a single telecommunications company, the diversity and richness of data may be maximized by expanding and utilizing mobile communication data from multiple telecommunications companies. In this case, not only the quantitative aspect but also the qualitative aspect of data may be improved. Based on this, the accuracy, stability, and reliability of location estimation may be improved.

According to the present disclosure, a deep learning-based prediction model learned using mobile communication data of multiple telecommunication companies may have the ability to accurately predict mobile communication data of other telecommunication companies using only data of a single telecommunication company. The model may recognize and learn complex patterns through various layers and nodes, and predict data of other telecommunication companies with high accuracy.

Through this process, unlike existing methods that only utilize limited data, the proposed method in the present disclosure may estimate a relatively more accurate location. This has the technical effect of providing a faster and more accurate location estimation service to users, thereby greatly improving the user experience.

The components described in the example embodiments may be implemented by hardware components including, for example, at least one digital signal processor (DSP), a processor, a controller, an application-specific integrated circuit (ASIC), a programmable logic element, such as an FPGA, GPU other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, it is intended that this disclosure embrace all other substitutions, modifications and variations belong within the scope of the following claims.

### STATEMENT REGARDING PRIOR DISCLOSURES BY THE INVENTOR OR A JOINT INVENTOR

The inventors of the present application have made related disclosure in Ju-Il Jeon et al., “Deep Learning-Based LTE Positioning Technology for Emergency Rescue,” 2023 IPNT Conference, Nov. 2, 2023. The related disclosure was made less than one year before the effective filing date (Nov. 20, 2023) of the present application. Accordingly, the related disclosure is disqualified as prior art under 35 USC 102(a)(1) against the present application. See 35 USC 102 (b)(1)(A).

What is claimed is:

1. A method for estimating a location based on mobile communication data, the method comprising:
collecting data from a plurality of mobile communication companies;
learning a prediction model based on the collected data of the plurality of mobile communication companies;
wherein the prediction model is designed to receive data of a single mobile communication company and predict data of another mobile communication company;
generating data of one or more other mobile communication companies by inputting data of a specific mobile communication company among the plurality of mobile communication companies into the learned prediction model; and
estimating a location of a user based on the data of the specific mobile communication company and the generated data of one or more other mobile communication companies.

2. The method of claim 1,
wherein collecting the data comprises performing a pre-processing process to convert the collected data into a data format for learning the prediction model.

3. The method of claim 2,
wherein the pre-processing process includes at least one of noise removal, outlier detection and removal, scaling for unit conversion, or feature extraction for the collected data.

4. The method of claim 2,
wherein the pre-processed data is stored and managed in the format of a database, and
wherein the learning of the prediction model is performed based on filtered data by loading data stored in the database.

5. The method of claim 1,
wherein the prediction model is updated at a pre-configured cycle based on at least one of changes in learning data or changes in user requirements.

6. The method of claim 1,
wherein the data of the specific mobile communication company is collected and transmitted by a user terminal and input into the learned prediction model through a pre-processing process including data format conversion.

7. The method of claim 1,
wherein the data of the multiple mobile communication companies are collected simultaneously based on signals transmitted and received by each mobile communication company.

8. The method of claim 1,
wherein the collected data includes at least one of information on signal strength, information on frequency range, information on cell identifier, or information on channel.

9. The method of claim 1,
wherein the prediction model is based on a deep learning neural network structure designed to extract and analyze features of the data of the single communication company and infer data of other communication companies.

10. An apparatus of performing location estimation based on mobile communication data, the apparatus comprising:
at least one processor and at least one memory,
wherein the processor is configured to:
collect data from a plurality of mobile communication companies;
learn a prediction model based on the collected data of the plurality of mobile communication companies;
wherein the prediction model is designed to receive data of a single mobile communication company and predict data of another mobile communication company;
generate data of one or more other mobile communication companies by inputting data of a specific mobile communication company among the plurality of mobile communication companies into the learned prediction model; and
estimate a location of a user based on the data of the specific mobile communication company and the generated data of one or more other mobile communication companies.

11. The apparatus of claim 10,
wherein the processor is configured to perform a pre-processing process to convert the collected data into a data format for learning the prediction model, when collecting the data.

12. The apparatus of claim 11,
wherein the pre-processing process includes at least one of noise removal, outlier detection and removal, scaling for unit conversion, or feature extraction for the collected data.

13. The apparatus of claim 11,
wherein the pre-processed data is stored and managed in the format of a database, and
wherein the learning of the prediction model is performed based on filtered data by loading data stored in the database.

14. The apparatus of claim 10,
wherein the prediction model is updated at a pre-configured cycle based on at least one of changes in learning data or changes in user requirements.

15. The apparatus of claim 10,
wherein the data of the specific mobile communication company is collected and transmitted by a user terminal and input into the learned prediction model through a pre-processing process including data format conversion.

16. The apparatus of claim 10,
wherein the data of the multiple mobile communication companies are collected simultaneously based on signals transmitted and received by each mobile communication company.

17. The apparatus of claim 10,
wherein the collected data includes at least one of information on signal strength, information on frequency range, information on cell identifier, or information on channel.

18. The apparatus of claim 10,
wherein the prediction model is based on a deep learning neural network structure designed to extract and analyze features of the data of the single communication company and infer data of other communication companies.

19. One or more non-transitory computer readable medium storing one or more instructions,
wherein the one or more instructions are executed by one or more processors and control an apparatus for performing location estimation based on mobile communication data to:
collect data from a plurality of mobile communication companies;
learn a prediction model based on the collected data of the plurality of mobile communication companies;
wherein the prediction model is designed to receive data of a single mobile communication company and predict data of another mobile communication company;
generate data of one or more other mobile communication companies by inputting data of a specific mobile communication company among the plurality of mobile communication companies into the learned prediction model; and
estimate a location of a user based on the data of the specific mobile communication company and the generated data of one or more other mobile communication companies.

20. The computer readable medium of claim 19,
wherein the prediction model is based on a deep learning neural network structure designed to extract and analyze features of the data of the single communication company and infer data of other communication companies.
